(19) United States
(12) Patent Application Publication
(10) Pub. No.: US 2023/0376972 A1
(43) Pub. Date: Nov. 23, 2023

(54) BUILDING A COMPLIANCE ARTIFACT

(71) Applicant: Regscale, Tysons, VA (US)

(72) Inventor: Jared Travis Howerton, Oak Ridge, TN (US)

(21) Appl. No.: 17/746,383

(22) Filed: May 17, 2022

(51) Int. Cl. G06Q 30/00

(52) U.S. Cl. CPC G06Q 30/018

(57) ABSTRACT

Disclosed is a system and a method for building a dynamic compliance artifact. Initially, a set of regulations and a set of controls associated with each regulation is determined. Further, a master regulation from the set of regulations is identified. Furthermore, one or more controls of the master regulation are mapped across the set of regulations. Upon mapping each control from the set of controls, a mapping matrix is generated. Subsequently, a compliance artifact for the master regulation is dynamically built into multiple versions based on the mapping matrix.

### PRIORITY INFORMATION

The present application does not claim a priority from any other application.

### TECHNICAL FIELD

The present subject matter described herein, in general, relates to a system and a method for building a compliance artifact. More particularly, building a compliance artifact covering multiple regulations.

### BACKGROUND

In cyber security compliance, an organization may often be subject to multiple regulations such as NIST 800-53, ISO 27001 (SOC 2), HIPAA, PCI, NERC/CIP, and the like. The organization needs to meet certain cyber security controls or requirements to comply with the regulations. The cyber security controls include user account management, patching, etc. Further, there exists great overlap in these regulations resulting in a large amount of rework to create a compliance document for each regulation. In such cases, the organization typically has to maintain huge spreadsheets containing a manual mapping of one regulation to another that is used to support audits. However, maintaining the spreadsheet required large amounts of manual labor. Further, it must be noted that the mapping is a text-based mapping that is fragile, error prone, and imprecise. Further, the organization has to justify the mapping in the audits. It must be noted that maintaining the mapping manually is a time consuming task.

### SUMMARY

Before the present system(s) and method(s), are described, it is to be understood that this application is not limited to the particular system(s), and methodologies described, as there can be multiple possible embodiments which are not expressly illustrated in the present disclosures. It is also to be understood that the terminology used in the description is for the purpose of describing the particular implementations or versions or embodiments only and is not intended to limit the scope of the present application. This summary is provided to introduce aspects related to a system and a method for building a compliance artifact. This summary is not intended to identify essential features of the claimed subject matter nor is it intended for use in determining or limiting the scope of the claimed subject matter.

In one implementation, a method for building a compliance artifact is disclosed. Initially, data related to multiple domains may be received. In one aspect, the data may be converted into a structured digital object related to each domain. Further, a set of regulations associated with each domain may be extracted by parsing the data. In one aspect, a regulation from the set of regulations may comprise a set of controls indicating a series of actions to be performed to comply with the regulation. Furthermore, overlapping controls across the set of regulations may be identified based on an analysis of the set of controls using an artificial intelligence technique. Subsequently, a master regulation from the set of regulations may be determined upon identifying the overlapping controls. In one aspect, the master regulation may be identified based on an analysis of the set of regulations using the artificial intelligence technique. Further, a mapping matrix may be generated by mapping one or more controls of the master regulation with the set of regulations. In one aspect, the one or more controls may be mapped using an artificial intelligence technique. The mapping may be performed based on historical data stored in a database. The historical data may comprise historical mapping of the set of regulations. Finally, a compliance artifact for the master regulation may be built based on the mapping matrix. In one aspect, the compliance artifact may comprise non-overlapping controls and overlapping controls. The compliance artifact may comprise security plans, components, projects, policies and supply chain contracts related to the set of regulations. In one aspect, the aforementioned method for building a compliance artifact may be performed by a processor using programmed instructions stored in a memory.

In another implementation, a non-transitory computer readable medium embodying a program executable in a computing device for building a compliance artifact is disclosed. The program may comprise a program code for receiving data related to multiple domains that may be received. In one aspect, the data may be converted into a structured digital object related to each domain. Further, the program may comprise a program code for extracting a set of regulations associated with each domain by parsing the data. In one aspect, a regulation from the set of regulations may comprise a set of controls indicating a series of actions to be performed to comply with the regulation. Furthermore, the program may comprise a program code for identifying overlapping controls across the set of regulations based on an analysis of the set of controls using an artificial intelligence technique. Subsequently, the program may comprise a program code for determining a master regulation from the set of regulations upon identifying the overlapping controls. In one aspect, the master regulation may be identified based on an analysis of the set of regulations using the artificial intelligence technique. The program may further comprise a program code for generating a mapping matrix by mapping one or more controls of the master regulation with the set of regulations. In one aspect, the one or more controls may be mapped using an artificial intelligence technique. The mapping may be performed based on historical data stored in a database. The historical data may comprise a historical mapping of the set of regulations. Finally, the program may comprise a program code for building a compliance artifact for the master regulation based on the mapping matrix. In one aspect, the compliance artifact may comprise non-overlapping controls and overlapping controls. The compliance artifact may comprise security plans, components, projects, policies and supply chain contracts related to the set of regulations.

### BRIEF DESCRIPTION OF THE DRAWINGS

The foregoing detailed description of embodiments is better understood when read in conjunction with the appended drawings. For the purpose of illustrating the present subject matter, an example is provided as figures, however, the invention is not limited to the specific method and system for building a compliance artifact as disclosed in the document and the figures.

The present subject matter is described in detail with reference to the accompanying figures. In the figures, the left-most digit(s) of a reference number identifies the figure in which the reference number first appears. The same numbers are used throughout the drawings to refer to various features of the present subject matter.

FIG. 1 illustrates a network implementation of a system for building a compliance artifact is disclosed, in accordance with an embodiment of the present subject matter.

FIG. 2 illustrates a flowchart for building a compliance artifact, in accordance with an embodiment of the present subject matter.

FIG. 3 illustrates a mapping of one or more controls, in accordance with an embodiment of the present subject matter.

FIG. 4 illustrates a mapping matrix, in accordance with an embodiment of the present subject matter.

FIG. 5 illustrates a method for building a compliance artifact, in accordance with an embodiment of the present subject matter.

The figures depict an embodiment of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “receiving”, “determining,” “generating,” “identifying,” “mapping,” “building,” and other forms thereof, are intended to be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any system and methods similar or equivalent to those described herein can be used in the practice or testing of embodiments of the present disclosure, the exemplary, system and methods are now described.

The disclosed embodiments are merely examples of the disclosure, which may be embodied in various forms. Various modifications to the embodiment will be readily apparent to those skilled in the art and the generic principles herein may be applied to other embodiments. However, one of ordinary skill in the art will readily recognize that the present disclosure is not intended to be limited to the embodiments described, but is to be accorded the widest scope consistent with the principles and features described herein.

The present subject matter discloses a system and a method for building a dynamic compliance artifact. Typically, an organization may be subject to multiple regulations such as NIST 800-53, ISO 27001 (SOC 2), HIPAA, PCI, and others. The regulations may require companies to meet certain cyber security controls or requirements such as user account management, patching, etc. There exists an overlap in these regulations resulting in a large amount of rework to create bespoke compliance documents for each regulation. More importantly, the present invention discloses an automatic process for mapping controls for the regulations. Further, the present invention allows a user to generate multiple versions of artifacts dynamically and in real-time for auditors in an output format the auditors expect to check. Initially, a master regulation from a set of regulations may be identified. Further, one or more controls of the master regulations may be mapped with the set of regulations. Based on the mapping, a compliance artifact for the master regulation may be built.

While aspects of the described system and method for building a compliance artifact may be implemented in any number of different computing systems, environments, and/or configurations, the embodiments are described in the context of the following exemplary system.

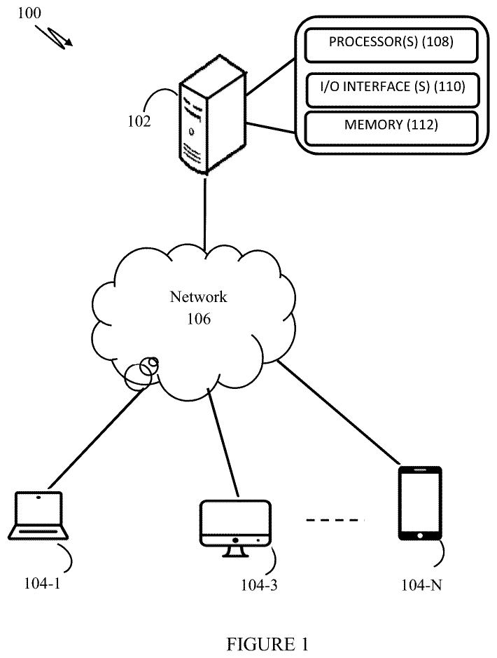

Referring now to FIG. 1, a network implementation 100 of a system 102 for building a compliance artifact is disclosed. It may be noted that one or more users may access the system 102 through one or more user devices 104-1, 104-2 . . . 104-N, collectively referred to as user devices 104, hereinafter, or applications residing on the user devices 104.

Although the present disclosure is explained considering that the system 102 is implemented on a server, it may be understood that the system 102 may be implemented in a variety of computing systems, such as a laptop computer, a desktop computer, a notebook, a workstation, a virtual environment, a mainframe computer, a server, a network server, a cloud-based computing environment. It will be understood that the system 102 may be accessed by multiple users through one or more user devices 104-1, 104-2 . . . 104-N. In one implementation, the system 102 may comprise the cloud-based computing environment in which the user may operate individual computing systems configured to execute remotely located applications. The user devices 104 are coupled to the system 102 for communications through a network 106.

In one implementation, the network 106 may be a wireless network, a wired network, or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

In one embodiment, the system 102 may include at least one processor 108, an input/output (I/O) interface 110, and a memory 112. The processor 108 may be implemented as one or more microprocessors, microcomputers, microcontrollers, digital signal processors, Central Processing Units (CPUs), state machines, logic circuitries, and/or any devices that manipulate signals based on operational instructions. Among other capabilities, the at least one processor 108 is configured to fetch and execute computer-readable instructions stored in the memory 112.

The I/O interface 110 may include a variety of software and hardware interfaces, for example, a web interface, a graphical user interface, and the like. The I/O interface 110 may allow the system 102 to interact with the user directly or through the client devices 104. Further, the I/O interface 110 may enable the system 102 to communicate with other computing devices, such as web servers and external data servers (not shown). The I/O interface 110 can facilitate multiple communications within a wide variety of networks and protocol types, including wired networks, for example, LAN, cable, etc., and wireless networks, such as WLAN, cellular, or satellite. The I/O interface 110 may include one or more ports for connecting a number of devices to one another or to another server.

The memory 112 may include any computer-readable medium or computer program product known in the art including, for example, volatile memory, such as static random access memory (SRAM) and dynamic random access memory (DRAM), and/or nonvolatile memory, such as read only memory (ROM), erasable programmable ROM, flash memories, hard disks, Solid State Disks (SSD), optical disks, and magnetic tapes. The memory 112 may include routines, programs, objects, components, data structures, etc., which perform particular tasks or implement particular abstract data types. The memory 112 may include programs or coded instructions that supplement applications and functions of the system 102. In one embodiment, the memory 112, amongst other things, serves as a repository for storing data processed, received, and generated by one or more of the programs or the coded instructions.

As there are various challenges observed in the existing art, the challenges necessitate the need to build the system 102 for building a compliance artifact. At first, a user may use the user device 104 to access the system 102 via the I/O interface 110. The user may register the user devices 104 using the I/O interface 110 in order to use the system 102. In one aspect, the user may access the I/O interface 110 of the system 102. The detailed functioning of the system 102 is described below with the help of figures.

The present subject matter describes the system 102 for building a compliance artifact for a regulation. In one aspect, the system 102 may comprise a drag and drop mapping tool that allows any two controls to be mapped to one another in a Graphical User Interface (GUI) or Application Programming Interface (APIs). Further, the system 102 may swap out a control language for one regulation to another regulation in real-time while reusing an implementation and evidence that is generated only once. The system 102 may generate multiple versions of an artifact dynamically and in real-time.

Initially, the system 102 may receive data related to multiple domains. The data may be received from a user. In one aspect, the system 102 may receive one of unstructured data or structured data. The unstructured data or the structured data may be received from a website, PDF format, Word document, or an Excel document and the like. Further, the system 102 may parse the unstructured data or the structured data using a set of proprietary Python scripts. Upon parsing the unstructured data or the structured data, the system 102 may generate the catalog/regulation data in a structured and consistent format. The data may comprise a document title, metadata, and associated requirements.

In one aspect, the data may be converted into a structured digital object related to each domain. The structured digital object may be referred as a digital object. The data may be represented as a collection of digital objects wrapped in hundreds of APIs for interaction with the outside world. The digital object may interact with the outside world through scanners, continuous monitoring tools, document updates, manual or automated audits/assessments, corrective actions, exceptions, asset changes such as retiring systems and adding new ones, patching and the like.

In one example, a Finance system may be used to manage a healthcare facility. Further, the multiple domains may comprise financials (PCI), healthcare (HIPAA), and privacy data (GPDR).

Once the data is received, the system 102 may extract a set of regulations associated with each domain. Further, the system 102 may extract a set of requirements associated with each regulation. The set of regulations and the set of requirements may be extracted by parsing the data. The data may be parsed using a Python script. Further, a regulation may comprise a set of controls. The set of controls may indicate a series of actions to be performed to comply with the regulation. In one example, each control may be referred as a requirement of the set of regulations that need to be met.

In one aspect, the set of regulations and the set of controls may be determined based on analyzing the data using a trained data model. The trained data model may comprise information related to a set of historical regulations, a set of historical controls associated with each historical regulation and the like.

In one embodiment, the system 102 may digitize each regulation and each requirement. The system 102 may generate a digital object for each regulation and associated requirement. The digital object may be presented in a machine readable format. The digital object of each regulation may be stored in a relational database. Further, the system 102 may convert the digital object of each regulation into a predefined format. The digital object may be converted into the predefined format using a predefined technique. The predefined format may be one of, but not limited to, a JSON format, an HTML format and an XML format.

Subsequently, the system 102 may identify overlapping controls across the set of regulations. The overlapping controls may be identified based on an analysis of the set of controls using an artificial intelligence technique. The overlapping controls may include one or more controls linked with multiple regulations from the set of regulations. In one example, the overlapping controls may include one or more controls linked with maximum regulations.

In one example, construe 10 controls in the set of controls refereed as control-1, control-2, . . . control-10. Further, the system 102 may identify that the control-4, control-7 and control-9 are linked with multiple regulations. The system 102 may further identify the control-4, control-7 and control-9 as the overlapping controls.

Upon identifying the overlapping controls, the system 102 may determine a master regulation from the set of regulations. The master regulation may be determined based on the overlapping controls. In one aspect, the master regulation may be identified based on an analysis of the set of regulations using the artificial intelligence technique. In one aspect, the master regulation may be a comprehensive regulation or high water mark to establish a robust baseline. In one embodiment, the master regulation may comprise multiple overlapping controls across the set of regulations.

Upon determining the master regulation, the system 102 may map one or more controls of the master regulation with the set of regulations. In one aspect, the mapping may be performed based on historical data stored in a database. The historical data may comprise historical mapping of the set of regulations. The system 102 may analyze the historical data. Based on the analysis, the one or more controls may be mapped for the set of regulations. In one aspect, the system 102 may use a Mapping Wizard for mapping the one or more controls from the master regulation.

In one embodiment, the one or more controls may be mapped using an Artificial Intelligence (AI) technique or a machine learning technique. The system 102 may use the historical mappings made by other users for the mapping of one or more controls. In one aspect, the system 102 may use Hamming or Levenshtein distance calculations for the mapping of the one or more controls.

In one embodiment, the system 102 may use a drag and drop technique for the mapping. The one or more controls of the master regulation may be mapped with the set of regulations using the drag and drop technique. In one aspect, the user may be able to drag the one or more controls from the master regulation. Further, the user may drop the one or more controls in the set of regulations onto the master regulation.

In one embodiment, the system 102 may reuse the mapping. The system 102 may export the mapping as a JSON object. The exported JSON object may be further reused for future mappings or mappings across application instances.

In one aspect, the system 102 may analyze the mapping of the one or more controls. Further, the system 102 may add an additional control from a regulation into the set of regulations. In the aspect, each regulation that is ingested may be stored as a collection of controls under a catalogue object. Further, the system 102 may allow the controls to be mapped for general equivalency across multiple catalogs. The unstructured regulations may exist as websites, PDFs, or Word documents that are digitally converted into structured catalogues for ease of precision mapping.

Further, the system 102 may generate a mapping matrix for the tenant. The mapping matrix may be generated upon mapping each control from the set of controls. The mapping matrix may indicate mapping of the one or more controls within the set of regulations. In one aspect, the mapping matrix may be a table like structure comprising rows and columns. In one embodiment, the system 102 may display the mapping matrix to the user in real-time. In another embodiment, the mappings exists as a structured JSON object. The user may be able to visualize the mapping in the mapping matrix.

Subsequently, the system 102 may build a compliance artifact for a master regulation based on the mapping matrix. The compliance artifact may comprise the overlapping controls and non-overlapping controls. The compliance artifact may comprise security plans, components, projects, policies and supply chain contracts related to the set of regulations. The compliance artifact may comprise the regulation, implementation details, evidence of compliance, and other relevant documentation that is output as a HTML or PDF report. The compliance artifact may be referred as a document comprising the plans and polices of the set of regulations. In one aspect, the system 102 may generate versions of the compliance artifact based on the mapping. The different versions of the compliance artifact may be used for different regulations from the set of regulations. In one aspect, the user may pick multiple versions of the compliance artifact to be generated based on the previous mapping.

The system 102 may automatically gather evidences for the compliance artifact from a repository. In one aspect, the evidence may be gathered using APIs, CLIs, and other scripts to collect data in real-time without manual labor. The gathering of the evidence may be performed by continuous monitoring platforms, Internet of Things (IoT) sensors, or other related applications.

In one aspect, the system 102 may create a new compliance artifact based on the set of regulations and the mapping. The new artifact may be generated using a wizard-driven builder.

In one aspect, the system 102 may parse the mapping using a bulk uploader script. Based on the parsing, the system 102 may create a new catalog for the regulation along with the one or more controls. The catalog may comprise the structured digital object consisting of a source regulation, related controls/requirements, and other metadata parsed from the unstructured data.

In one embodiment, the system 102 may allow a parent regulation to be dynamically swapped while reusing an implementation, evidence, and assessment data. Further, the system 102 may allow an export and import of the mappings as a JSON object. The export and import may allow portability between different instances. The export and import may allow selling the mapping in a compliance marketplace. Based on the portability of the JSON object between instances, the system 102 may monetize digital regulations and mappings in a future compliance marketplace.

In one aspect, the system 102 may maintain a list of suggested implementations that are anonymized to assist with implementing the regulation using artificial intelligence. In one embodiment, the system 102 may collect anonymous data to build a compliance lake to fuel a recommendation Artificial Intelligence (AI) engine.

In one embodiment, the system 102 may create and keep updated machine readable versions of each compliance regulation. Further, the system 102 may accurately perform the mapping of controls for the regulations using a drag and drop interface. The system 102 may represent the controls for the regulations as digital objects. In one aspect, the system 102 may handle multi-dimensional complexity. The system 102 may comprise three layers where change is possible. The system 102 may comprise change to a regulation that needs to flow back into an artifact. The system 102 may comprise change to the mapping between the set of regulations. The system 102 may comprise change to an assessment evidence and implementation data that needs to flow across mappings. In one embodiment, the system 102 may allow all three of these changes and their inter-dynamics to create a seamless and efficient user experience that saves time and money.

In one embodiment, the system 102 may build a machine readable regulation. Further, the system 102 may handle the multi-dimensional complexity of three layers of moving parts. The system 102 may be moving from imprecise and fuzzy text matching to strongly typed matching of objects based on GUIDs. The system 102 may toggle artifacts in real-time based on changes in any of the three layers.

In one aspect, the system 102 may enable low cost or no cost to maintain changes in the regulations. The system 102 may enable building mappings faster than using Excel. The system 102 may allow re-use of assessments and evidence which decreases costs. The system 102 may provide a dramatically improved user experience for customers through a User Interface (UI) which masks all the underlying complexity. In one exemplary embodiment, an organization may deploy a new Finance system that is used to manage a healthcare facility. The system manages financials, healthcare and private data. The system comprises PCI for payments, Health Insurance Portability and Accountability Act (HIPAA) for healthcare data and General Data Protection Regulation (GDPR) for privacy.

Traditionally, the organization may need to build out artifacts separately showing compliance with each of these regulations. In one aspect, the organization may build a master spreadsheet that the organization must then defend to auditors. In another aspect, the organization may manually build three different versions of the artifact for different auditors. In the system 102 of the present invention, the system 102 may first builds a security plan against PCI as PCI is a robust framework and controls of the PCI will be inclusive of the others. Further, the user may print out multiple artifacts for PCI, HIPAA, and GDPR. Thus, with 3 clicks in the system 102, the user may be able to toggle between versions of the plans while maintaining one set of evidence from assessments.

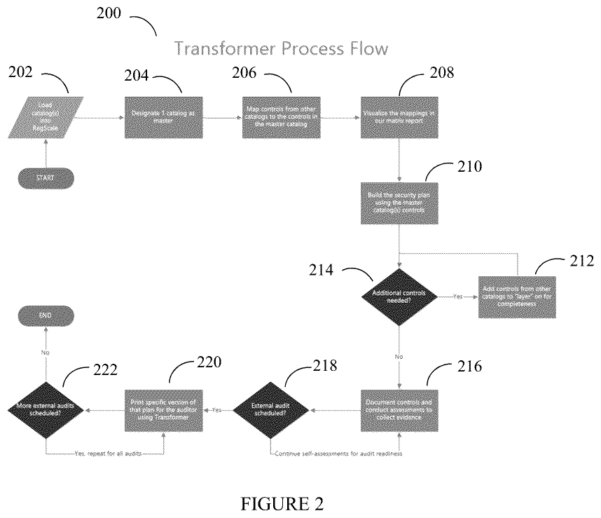

Referring now to FIG. 2, a flowchart 200 for building a compliance artifact is disclosed in accordance with an embodiment of the present subject matter. At block 202, a set of regulations may be loaded in the system 102. The system 102 may be referred to as the Regscale platform. The set of regulations may be referred to as a set of catalogs. The set of catalogs may be associated with a single tenant within the application.

Further, at block 204, a master regulation from the set of regulations may be identified. The master regulation may be identified using an artificial intelligence technique. Furthermore, at block 206, one or more controls of the master regulation may be mapped with a subset of regulations.

Subsequently, at block 208, a mapping report may be displayed to a user. The mapping report may comprise a mapping matrix. The mapping matrix may indicate the mapping of the one or more controls for the set of regulations.

At block 210, a security plan or other modules such as component, project, supply chain, or policy may build for the set of regulations. The security plan may be built based on the mapping. The security plan of the set of regulations may be dependent on an artifact of the master regulation.

Further, at block 214, the system 102 may check if an additional control is required for the set of regulations. If the additional control is required, the additional control from a subset of regulations may be added at block 212. At block 216, the system 102 may collect a set of evidence for the set of mapped controls using automation i.e., APIs/CLIs or via manual collection by audit. The set of evidence may be re-used across all mapped controls significantly lowering manual labour costs.

Subsequently, at block 218, an external audit may be scheduled. Further, the system 102 may continuously self-assess the mapping for audit readiness. The mapping may provide increased audit coverage using one set of evidence.

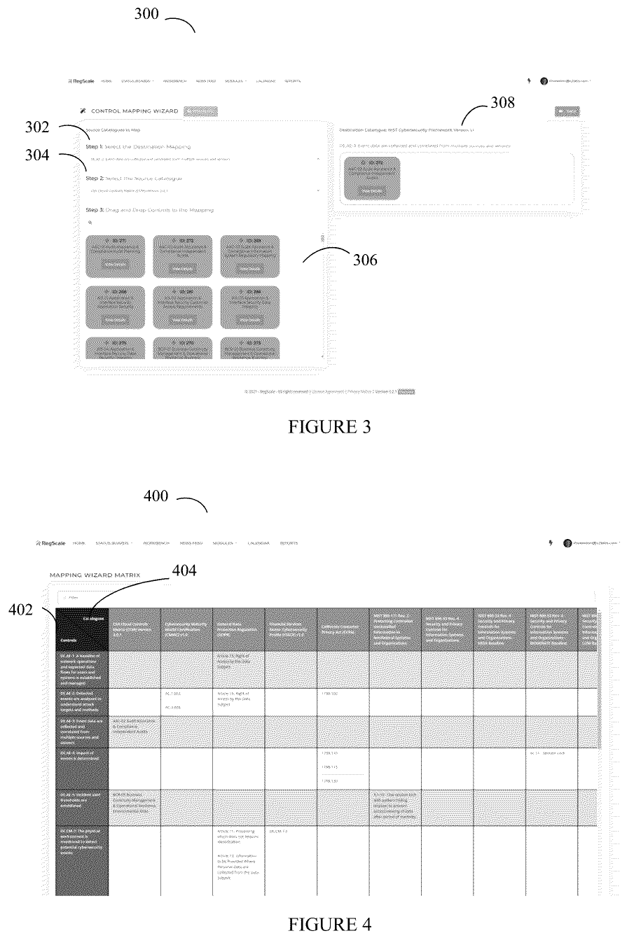

Referring now to FIG. 3, a mapping 300 of one or more controls is disclosed in accordance with an embodiment of the present subject matter. In one embodiment, a control mapping wizard is shown. The control mapping wizard may comprise a selection of destination mapping 302 and a selection of source catalogue 304. In one aspect, a user may select a source regulation at the selection of source catalogue 304 and a destination regulation at the selection of destination mapping 302. Further, the system 102 may drag one or more controls 306. The one or more controls may be further dropped in a destination control 308 of the destination regulation.

Referring now to FIG. 4, a mapping matrix 400 is disclosed in accordance with an embodiment of the present subject matter. In one embodiment, the mapping matrix may comprise catalogues 404 and controls 402. The catalogues 404 may indicate a set of regulations, and the controls 402 may indicate a set of controls that are child records of the parent catalog. The mapping matrix may be in a form of rows and columns. The mapping matrix may indicate mapping of one or more controls for regulations from the set of regulations. The mapping may continue to the “n” across all available regulations loaded as catalogs in the system.

In one embodiment, a first control may be DE.AE-1 from NIST Cyber Security Framework (CSF): a baseline of network operations and expected data flows for user and systems is established and managed. The first control may then be mapped to the catalogue General Data Protection Regulation (GDPR). The mapping may comprise Article 15: Right of Access by the Data subject. Similarly, the set of controls may be mapped between the catalogues.

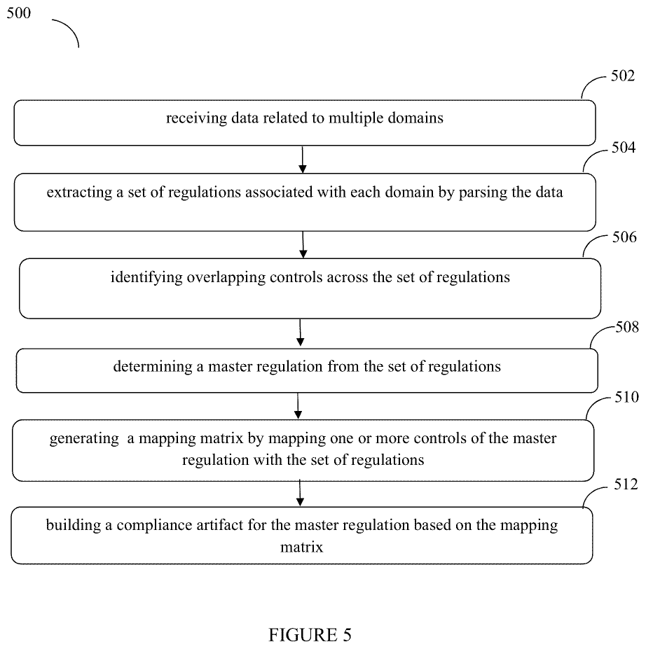

Referring now to FIG. 5, a method 500 for building a compliance artifact is shown, in accordance with an embodiment of the present subject matter. The method 500 may be described in the general context of computer executable instructions. Generally, computer executable instructions can include routines, programs, objects, components, data structures, procedures, modules, functions, etc., that perform particular functions or implement particular abstract data types.

The order in which the method 500 is described is not intended to be construed as a limitation, and any number of the described method blocks can be combined in any order to implement the method 500 or alternate methods for building a compliance artifact. Additionally, individual blocks may be deleted from the method 500 without departing from the spirit and scope of the subject matter described herein. Furthermore, the method 500 for building a compliance artifact can be implemented in any suitable hardware, software, firmware, or combination thereof. However, for ease of explanation, in the embodiments described below, the method 500 may be considered to be implemented in the above described system 102.

At block 502, data related to multiple domains may be received. In one aspect, the data may comprise a digital object related to each domain. The domain may include functional areas such as cyber security, environmental management, and quality assurance.

At block 504, a set of regulations associated with each domain may be extracted by parsing the data. In one aspect, a regulation from the set of regulations comprises a set of controls indicating a series of actions to be performed to comply with the regulation.

At block 506, overlapping controls across the set of regulations may be identified based on an analysis of the set of controls using an artificial intelligence technique.

At block 508, a master regulation from the set of regulations may be determined based upon identifying the overlapping controls. In one aspect, the master regulation may be identified based on an analysis of the set of regulations using the artificial intelligence technique.

At block 510, a mapping matrix may be generated by mapping one or more controls of the master regulation with the set of regulations. In one aspect, the one or more controls may be mapped using artificial intelligence technique. The mapping may be performed based on historical data stored in a database. The historical data may comprise historical mapping of the set of regulations.

At block 512, a compliance artifact for the master regulation may be built based on the mapping matrix. In one aspect, the compliance artifact may comprise non-overlapping controls and overlapping controls. The compliance artifact may comprise security plans, components, projects, policies and supply chain contracts related to the set of regulations.

Exemplary embodiments discussed above may provide certain advantages. Though not required to practice aspects of the disclosure, these advantages may include those provided by the following features.

Some embodiments of the system and the method enable accurately mapping controls as digital objects allowing enhanced precision in mappings.

Some embodiments of the system and the method enable maintaining changes in regulations.

Some embodiments of the system and the method enable building a compliance artifact for regulations based on a master artifact of a master regulation.

Some embodiments of the system and the method enable reusing mapping by exporting the mappings of the regulations and the controls.

Although implementations for methods and system for building a compliance artifact have been described in language specific to structural features and/or methods, it is to be understood that the appended claims are not necessarily limited to the specific features or methods described. Rather, the specific features and methods are disclosed as examples of implementations for building the compliance artifact.

1. A method for building a compliance artifact, the method comprising:
receiving, by a processor, data related to multiple domains;
converting, by the processor, the data into a structured digital object related to a given domain from the multiple domains;
extracting, by the processor, a set of regulations for the given domain by parsing the digital object, wherein a regulation from the set of regulations comprises a set of controls, each indicative of one or more actions to be performed to comply with the regulation;
analyzing, by the processor, the set of controls to identify overlapping controls, wherein the overlapping controls at least include one or more controls linked with multiple regulations from the set of regulations, and wherein the analysis is performed at least based in part on information related to a set of historical regulations, and a set of historical controls associated with each historical regulation;
identifying, by the processor, at least one regulation of the set of regulations as a master regulation, based on the overlapping controls;
displaying, by the processor, in real-time, a mapping matrix generated by mapping the overlapping controls of the master regulation with each of the set of regulations;
dynamically building, by the processor, a compliance artifact based on the master regulation, responsive to generating the mapping matrix, wherein the compliance artifact comprises a set of evidence related to the mapped overlapping controls, and wherein the set of evidence is collected automatically in real-time using Application Programming Interface (APIs) and Command Line Interface (CLIs) that connect to one or more of continuous monitoring systems, Internet of Things (IoT) platforms, and customer applications;
detecting, by the processor, a change in one or more regulations from the set of regulations, the mapping matrix, or the set of evidence; and
toggling, by the processor, between multiple versions of the compliance artifact in real-time, responsive to detecting the change.

2. The method as claimed in claim 1, wherein the data is received as one of unstructured data or structured data from one of website, PDF format, Word document, and Excel document.

3.-5. (canceled)

6. The method as claimed in claim 1, further comprising reusing the mapping by exporting the mapping as a JSON object from a tenant.

7. The method as claimed in claim 1, wherein the one or more overlapping controls of the master regulation are mapped with the set of regulations using a drag and drop technique.

8.-9. (canceled)

10. A system for building a compliance artifact, the system comprising:
a memory; and
a processor coupled to the memory, wherein the processor is configured to execute instructions stored in the memory to:
receive data related to multiple domains;
convert the data into a structured digital object related to a given domain from the multiple domains;
extract a set of regulations for the given domain by parsing the digital object, wherein a regulation from the set of regulations comprises a set of controls, each indicative one or more actions to be performed to comply with the regulation;
analyze the set of controls to identify overlapping controls, wherein the overlapping controls at least include one or more controls linked with multiple regulations from the set of regulations, and wherein the analysis is performed at least based in part on information related to a set of historical regulations, and a set of historical controls associated with each historical regulation;
identify at least one regulation of the set of regulations as a master regulation, based on the overlapping controls;
display, in real-time, a mapping matrix generated by mapping the overlapping controls of the master regulation with each of the set of regulations;
dynamically build a compliance artifact based on the master regulation dynamically responsive to generating the mapping matrix, wherein the compliance artifact comprises a set of evidence related to the mapped overlapping controls, and wherein the set of evidence is collected automatically in real-time using Application Programming Interface (APIs) and Command Line Interface (CLIs) that connect to one or more of continuous monitoring systems, Internet of Things (IoT) platforms, and customer applications;
detecting a change in one or more regulations from the set of regulations, the mapping matrix, or the set of evidence; and
toggle between multiple versions of the compliance artifact in real-time, responsive to detecting the change.

11. The system as claimed in claim 10, wherein the data is received as one of unstructured data or structured data from one or more of a website, PDF format, Word document or Excel document.

12.-14. (canceled)

15. The system as claimed in claim 10, wherein the processor is further configured to reuse the mapping by exporting the mapping as a JSON object from a tenant.

16.-18. (canceled)

19. A non-transitory computer program product having embodied thereon a computer program for building a compliance artifact, the computer program product storing instructions, the instructions comprising instructions for:
receiving data related to multiple domains;
converting the data into a structured digital object related to a given domain from the multiple domains;
extracting a set of regulations for the given domain by parsing the digital object, wherein a regulation from the set of regulations comprises a set of controls, each indicative of one or more actions to be performed to comply with the regulation;
analyzing the set of controls to identify overlapping controls, wherein the overlapping controls at least include one or more controls linked with multiple regulations from the set of regulations, and wherein the analysis is performed at least based in part on a set of historical regulations, and a set of historical controls associated with each historical regulation;
identifying at least one regulation of the set of regulations as a master regulation based on the overlapping controls;
displaying a mapping matrix in real-time, the mapping matrix generated by mapping the overlapping controls of the master regulation with each of the set of regulations;
dynamically building the compliance artifact based on the master regulation responsive to generating the mapping matrix, wherein the compliance artifact comprises a set of evidence related to the mapped overlapping controls, and wherein the set of evidence is collected automatically in real-time using Application Programming Interface (APIs) and Command Line Interface (CLIs) that connect to one or more of continuous monitoring systems, Internet of Things (IoT) platforms, and customer applications;
detecting a change in regulations from the set of regulations, the mapping matrix, or the set of evidence; and
toggling, between multiple versions of the compliance artifact in real-time responsive to detecting the change.

20. The method as claimed in claim 1, wherein the received data is converted into the structured digital object related to a domain of the multiple domains, wherein the structured digital object is wrapped in APIs.

21. The method as claimed in claim 1, wherein the structured digital object is configured to interact through scanners, continuous monitoring tools, document updates, automated audits, corrective actions, exceptions, and asset changes, and adding new ones, and patching.

22. The method as claimed in claim 1, wherein the overlapping controls are mapped using an artificial intelligence technique, and wherein the mapping is performed based on historical data stored in a database, and wherein the historical data comprises historical mapping of the set of regulations, and wherein the mapping of the overlapping controls is continuously assessed for audit readiness, and wherein an additional control associated with the set of regulations is added in the mapping matrix using a drag and drop technique based on an input from a user.
